(19) United States
(12) Patent Application Publication
(10) Pub. No.: US 2025/0312899 A1
(43) Pub. Date: Oct. 9, 2025

(54) OFFSET DRIVE ACCESSORY FOR REACTION ARM TOOL

(71) Applicant: MILWAUKEE ELECTRIC TOOL CORPORATION, Brookfield, WI (US)

(72) Inventor: Mitchell Gibson, New Berlin, WI (US)

(21) Appl. No.: 19/170,691

(22) Filed: Apr. 4, 2025

Related U.S. Application Data
(60) Provisional application No. 63/574,566, filed on Apr. 4, 2024.

(51) Int. Cl. B25B 23/00; B25B 21/00; B25F 5/00

(52) U.S. Cl. CPC B25B 23/0078; B25F 5/001; B25B 21/002

(57) ABSTRACT

An offset drive accessory for a power tool includes a housing, and an input gear supported within the housing. The input gear is configured to rotate about a first axis. The offset drive accessory further includes an output gear supported within the housing. The output gear is configured to rotate about a second axis offset from the first axis. The output gear is couplable to a removable insert that is engageable with a fastener to transmit torque from the output gear to the fastener. The offset drive accessory further includes an idler gear supported within the housing. The idler gear is meshed with the input gear and the output gear such that the idler gear is configured to transmit torque from the input gear to the output gear. The offset drive accessory also includes a reaction arm removably coupled to the housing.

### CROSS-REFERENCE TO RELATED APPLICATIONS

The present application claims priority to U.S. Provisional Patent Application No. 63/574,566, filed Apr. 4, 2024, the entire contents of which are incorporated herein by reference.

### FIELD

The present disclosure relates to accessories for power tools, and more specifically to offset drive accessories for reaction arm tools.

### BACKGROUND

Reaction arm tools are a form of rotary power tool used to drive fasteners, such as nuts and bolts, particularly in high torque applications. Reaction arm tools include a reaction arm fixed to a housing of the tool and engageable with a fixed structure (e.g., an adjacent fastener in a bolt pattern). When applying torque to a fastener, the reaction arm transmits the reaction torque to the fixed structure rather than to a user holding the tool.

### SUMMARY

Reaction arm tools may be relatively large due in order to provide high output torque capabilities, which may make it difficult to align the tool with a fastener in a compact space with limited access. Accordingly, the present disclosure provides, among other things, an offset drive accessory suitable for use with a reaction arm tool. The offset drive accessory may include one or more reaction arms to transmit reaction torque from the offset drive accessory to a fixed structure.

Known offset drive accessories include an input gear and an output gear, and the output gear is removable to allow a user to swap out smaller output gears for larger output gears, and vice versa, for compatibility with fasteners of different sizes. However, by swapping out and changing the size of the output gears, the gear ratio between the input gear and the output gear changes, and a user is then required to calculate the output torque of the new output gear due to the new size, and thus, the new gear ratio associated with the new output gear. This can often be inconvenient for a user, and in some instances, lead to user error.

An offset drive accessory embodying aspects of the present disclosure may also be compatible with a variety of attachments suitable for driving differently sized fasteners, without varying a gear ratio between the torque input (from the reaction arm tool) and the torque output (to the fastener). This makes it easier for a user to determine the torque being applied to the fastener without needing to account for different gear ratios.

For example, in some aspects, the techniques described herein relate to an offset drive accessory for a power tool, including: a housing; an input gear supported within the housing, the input gear configured to rotate about a first axis; an output gear supported within the housing, the output gear configured to rotate about a second axis offset from the first axis, wherein the output gear is couplable to a removable insert that is engageable with a fastener to transmit torque from the output gear to the fastener; an idler gear supported within the housing, the idler gear meshed with the input gear and the output gear such that the idler gear is configured to transmit torque from the input gear to the output gear; and a reaction arm removably coupled to the housing.

In some aspects, the techniques described herein relate to an offset drive accessory for a power tool, including: a housing, an input gear supported by the housing and configured to be rotatably driven about a first axis by an output drive of the power tool; an output gear supported by the housing and rotatable about a second axis parallel to the first axis in response to rotation of the input gear, wherein the output gear includes an output receptacle; a first insert including a first shank shaped to be received in the output receptacle and a first work end having a first geometry; and a second insert including a second shank shaped to be received in the output receptacle and a second work end having a second geometry different than the first geometry, wherein the first insert and the second insert are interchangeably couplable with the output gear.

In some aspects, the techniques described herein relate to an offset drive accessory for a power tool, including: a housing, an input gear supported by the housing and configured to be rotatably driven about a first axis by an output drive of the power tool; and an output gear supported by the housing and rotatable about a second axis parallel to the first axis in response to rotation of the input gear, wherein the output gear includes an output receptacle, wherein the offset drive accessory includes a first configuration in which the offset drive accessory is configured to drive a fastener of a first size, wherein the offset drive accessory includes a second configuration in which the offset drive accessory is configured to drive a fastener of a second size different than the first size, and wherein a gear ratio between the input gear and the output gear remains constant in the first configuration and the second configuration.

Other aspects of the disclosure will become apparent by consideration of the detailed description and accompanying drawings.

### BRIEF DESCRIPTION OF THE DRAWINGS

FIG. 1 is a front perspective view of a power tool and an offset drive accessory for the power tool according to an embodiment of the disclosure.

FIG. 2A is a front perspective view of the accessory of FIG. 1 with a first insert.

FIG. 2B is a rear perspective view of the accessory of FIG. 1 with the first insert.

FIG. 3 is an exploded view of the accessory of FIG. 1 and the first insert.

FIG. 4 is a cross-sectional view of the accessory taken along line 4-4 in FIG. 2B.

FIG. 5A is a front plan view of the accessory of FIG. 1 with the first insert.

FIG. 5B is a rear plan view of the accessory of FIG. 1 with the first insert.

FIG. 6 is a partially exploded view of the accessory of FIG. 1 and the first insert.

FIG. 7A is a front plan view of the accessory of FIG. 1 with a second insert.

FIG. 7B is a front perspective view of the accessory of FIG. 1 with the second insert.

FIG. 7C is a partially exploded view of the accessory of FIG. 1 and the second insert.

FIG. 8A is a top view of the accessory of FIG. 1 with the first insert.

FIG. 8B is a top view of the accessory of FIG. 1 with the second insert.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

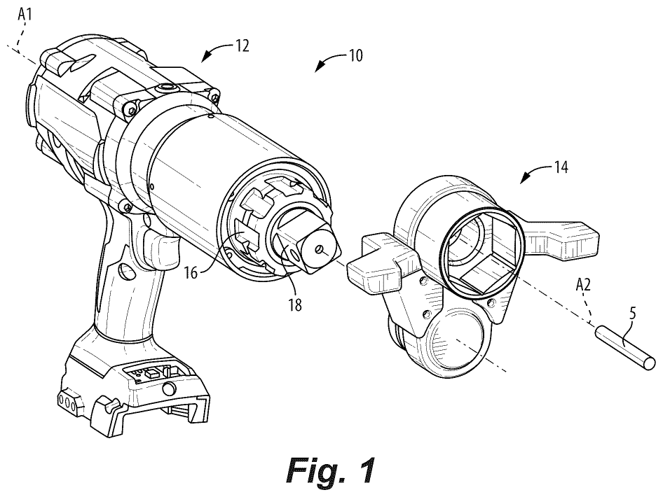

FIG. 1 illustrates a power tool 10 and an offset device or offset drive accessory 14 for the power tool 10 according to an embodiment of the present disclosure. The illustrated power tool 10 is a rotary power tool, and, more specifically, a reaction arm tool. The power tool 10 includes a housing 12 enclosing a drive mechanism (e.g., an electric motor and a transmission, such as a multi-stage planetary transmission; not shown), an attachment interface 16 fixed to the housing, and a drive output 18 extending from the housing 12 (and through the attachment interface 16). The drive output 18 is operably coupled to the drive mechanism to apply torque to a workpiece 5 (e.g., a fastener) about a drive axis or first axis A1 via the drive output 18. The illustrated drive output 18 is configured as a square drive output with a generally square cross-section in a direction transverse to the axis A1. As such, the drive output 18 is configured for attachment to corresponding (i.e., square) drive tool bits, such as sockets (not shown). In other embodiments, the drive output 18 may have any other desired shape. In some embodiments, a reaction arm (not shown) may be coupled to the attachment interface 16 to rotationally fix the reaction arm to the housing 12 (e.g., via cooperating splines on the reaction arm and the attachment interface 16). The reaction arm may then be engaged with a fixed structure (e.g., an adjacent fastener, a wall, a clamp, etc.) during operation of the power tool 10 to transmit reaction torque, generated when applying torque to the workpiece 5, to the fixed structure rather than to a user of the power tool 10.

In the illustrated embodiment, the offset drive accessory 14 is removably couplable to the power tool 10. For example, the offset drive accessory 14 may be interchangeable with the reaction arm (not shown). With the offset drive accessory 14 coupled to the power tool 10, the offset drive accessory 14 is configured to offset the output of the power tool 10 from the first axis A1 such that the power tool 10 is configured to apply torque about a second axis A2, as will be described in more detail below. The offset drive accessory 14 is additionally configured to brace the tool 10 against the fixed structure to bear the reaction torque. As such, when using the offset drive accessory 14, a user operating the power tool 10 does not experience the reaction torque on their hands and wrists allowing for higher torque outputs, repeatability, and reduced user fatigue.

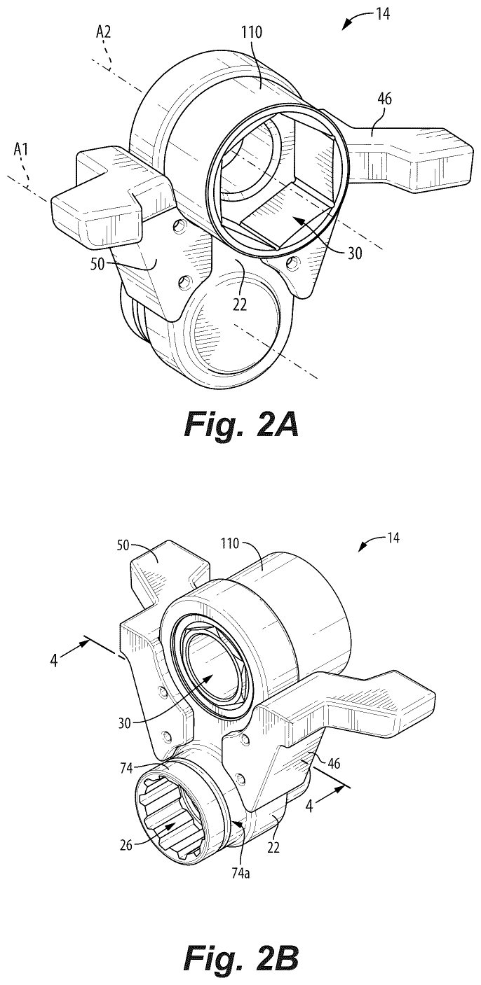

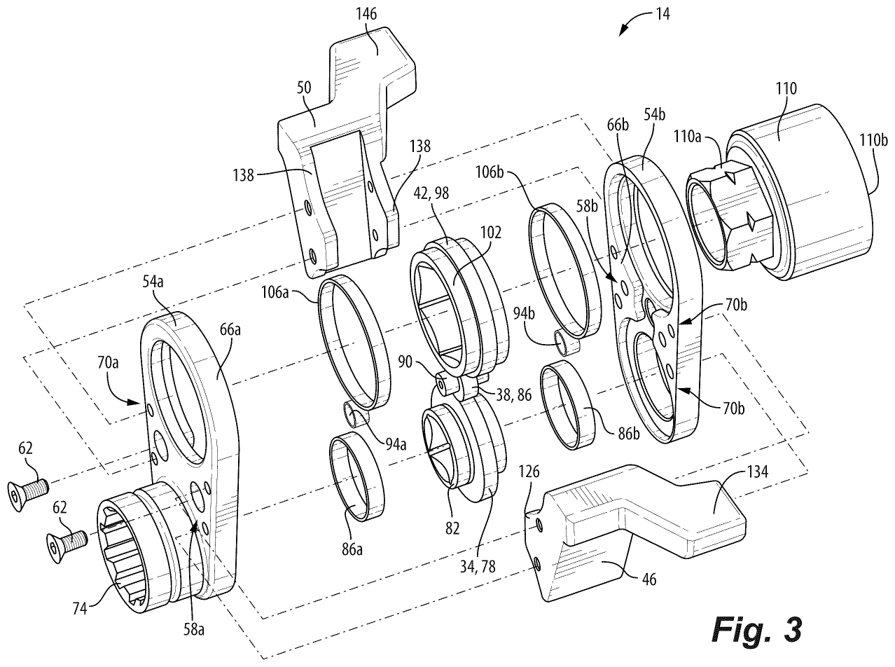

With reference to FIGS. 2A-3, the offset drive accessory 14 includes a housing 22, an input 26 configured to attach to and receive torque from the power tool 10, and output 30 configured to deliver torque to the workpiece 5. The housing 22 encloses an input gear 34, an idler gear 38, and an output gear 42 (FIG. 3), described in greater detail below. The illustrated offset drive accessory 14 also includes a first reaction arm 46 and a second reaction arm 50.

As illustrated in FIGS. 3-5A, the illustrated housing 22 includes a first housing portion 54a and a second housing portion 54b that may be coupled together to form the housing 22. Each of the first housing portion 54a and the second housing portion 54b includes housing fastener receptacles 58a, 58b that are configured to receive fasteners 62 (e.g., screws) to couple the first housing portion 54a and the second housing portion 54b together. In other embodiments, the housing portions 54a, 54b may be coupled together in other ways (e.g., a snap-fit, welding, brazing, etc.).

In the illustrated embodiment, the first housing portion 54a includes a first coupling edge 66a, and the second housing portion 54b includes a second coupling edge 66b. The coupling edges 66a, 66b are the inner edges, or sides, of the first housing portion 54a and the second housing portion 54b, respectively. As such, when the first housing portion 54a and the second housing portion 54b are coupled together, the first coupling edge 66a and the second coupling edge 66b are in contact with each other along a plane that is perpendicular to both the first axis A1 and the second axis A2. Each of the illustrated first housing portion 54a and the second housing portion 54b additionally includes reaction arm fastener receptacles 70a, 70b that are configured to receive fasteners for coupling the first reaction arm 46 and the second reaction arm 50 to the housing 22. In some embodiments, the first reaction arm 46 and the second reaction may be selectively coupled to and removably from the housing 22, such that only one of the reaction arms 46, 50 may be coupled to the housing 22 at a time. For example, the first reaction arm 46 may be coupled to the housing 22 when driving fasteners in a forward (e.g., clockwise or tightening) direction, and the second reaction arm 50 may be coupled to the housing 22 when driving fasteners in a reverse (e.g., counterclockwise or loosening) direction.

With reference to FIGS. 2B, 4, and 5B, the input 26 is positioned proximate a first end 22a (e.g., a bottom end) of the housing 22, and the output 30 is positioned proximate a second end 22b (e.g., a top end) of the housing 22. The first housing portion 54a includes an internally splined boss or protrusion 74 that extends away from the second housing portion 54b and that has an opening for receiving the attachment interface 16 of the power tool 10. That is, the splined protrusion 74 of the input 26 is configured to receive complementary shaped splines on the attachment interface 16 of the power tool 10 to facilitate a secure connection between the power tool 10 and the offset drive accessory 14. The second housing portion 54b includes a wall to close off the input 26 such that the input 26 does not extend all the way through the second housing portion 54b. In the illustrated embodiment, the splined protrusion 74 additionally includes a groove 74a formed in an exterior surface of the splined protrusion 74. The groove 74a may interface with a retaining mechanism, detent, etc. (not shown) to selectively retain the accessory 14 on the power tool 10.

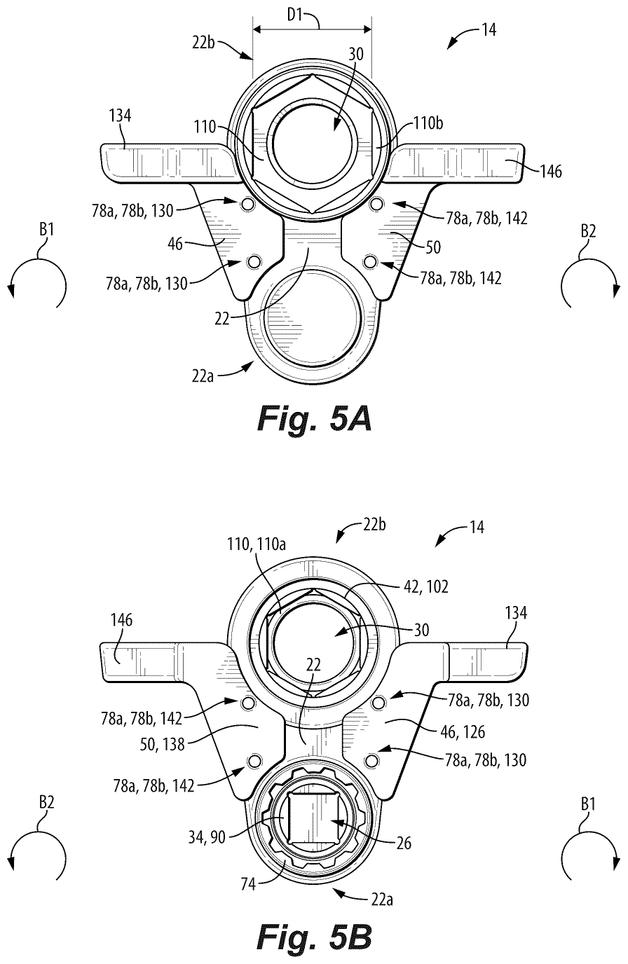

With reference to FIGS. 3, 4, and 5B, the input gear 34 of the input 26 is supported within the housing 22 between the first housing portion 54a and the second housing portion 54b. Specifically, the input gear 34 is supported at the first end 22a (e.g., the bottom end) of the housing 22 within the input 26. The input gear 34 includes a main body 78 having a plurality of gear teeth formed around the perimeter of the main body and an input receptacle 82 that protrudes rearwardly and forwardly of the main body 78. A first input bearing 86a is mounted to the input receptacle 82 on a rear side of the input gear 34 to support the input gear 34 for rotation relative to the first housing portion 54a, and a second input bearing 86b is mounted to the input receptacle 82 on a front side of the input gear 34 to support the input gear 34 for rotation relative to the second housing portion 54b. An inner perimeter of the input receptacle 82 is complementarily shaped (e.g., square shaped) to engage and receive a rotational input from the drive output 18 of the power tool 10 (FIG. 1). As such, the power tool 10 is configured to drive the input gear 34 about the first axis A1 when the offset drive accessory 14 is coupled to the power tool 10, via the input receptacle 82, along a forward rotational direction B1 (e.g., a clockwise direction with respect to the orientation of FIG. 5A) and a rearward rotational direction B2 (e.g., a counterclockwise direction with respect to the orientation of FIG. 5A). In the illustrated embodiment, the inner perimeter of the input receptacle 82 is substantially square-shaped. In other embodiments, the input receptacle 82 may be formed in other shapes.

The idler gear 38 is supported within the housing 22 between the first housing portion 54a and the second housing portion 54b. Specifically, the idler gear 38 is supported between the input gear 34 and the output gear 42. The idler gear 38 includes a main body 86 and a protruding portion 90 that extends rearwardly and forwardly from the main body 86. A first idler bearing 94a is mounted to the protruding portion 90 on a rear side of the idler gear 38 to support the idler gear 38 for rotation relative to the first housing portion 54a, and a second idler bearing 94b is mounted to the protruding portion 90 on a front side of the idler gear 38 to support the idler gear 38 for rotation relative to the second housing portion 54b. The idler gear 38 is configured to transfer torque, or rotation, from the input gear 34 to the output gear 42. Specifically, the idler gear 38 is meshed with the input gear 34 such that when the power tool 10 drives rotation of the input gear 34, the input gear 34 is configured to drive rotation of the idler gear 38 in an opposite direction relative to the rotational direction of the input gear 34. That is, if the power tool 10 drives the input gear 34 in the forward rotational direction B1, the input gear 34 will drive the idler gear 38 in the rearward rotational direction B2. If the power tool 10 drives the input gear 34 in the rearward rotational direction B2, the input gear 34 will drive the idler gear 38 in the forward rotational direction B1. The idler gear 38 is also meshed with the output gear 42. As such, when the input gear 34 drives the idler gear 38, the idler gear 38, in turn, is configured to drive rotation of the output gear 42. Specifically, the idler gear 38 is configured to drive, or transfer rotation to, the output gear 42 such that the output gear 42 rotates in the same direction as the input gear 34.

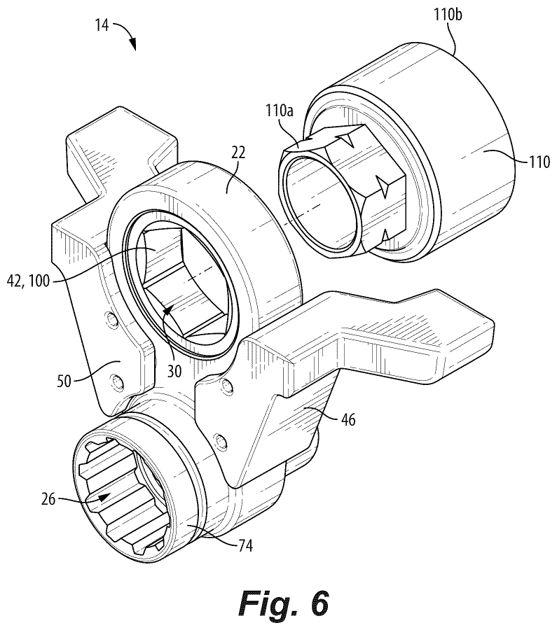

With reference to FIGS. 3, 4, and 6, the output gear 42 of the output 30 is supported within the housing 22 between the first housing portion 54a and the second housing portion 54b. The output gear 42 is configured to rotate about the second axis B2 in response to receiving a rotational input from the idler gear 38. The output gear 42 includes a main body 98 having a plurality of gear teeth formed around the perimeter of the main body 98 and an output receptacle 102 that protrudes rearwardly and forwardly of the main body 98. A first output bearing 106a is mounted to the output receptacle 102 on a rear side of the output gear 42 to support the output gear 42 for rotation relative to the first housing portion 54a, and a second output bearing 106b is mounted to the output receptacle 102 on a front side of the output gear 42 to support the output gear 42 for rotation relative to the second housing portion 54b. An inner perimeter of the output receptacle 102 is complementarily shaped to receive and engage a plurality of fastener engagement inserts, as will be described in more detail below. In the illustrated embodiment, as best illustrated in FIG. 6, the inner perimeter of the output receptacle 102 is hexagonally shaped. In other embodiments, the inner perimeter of the output receptacle 102 may have other shapes.

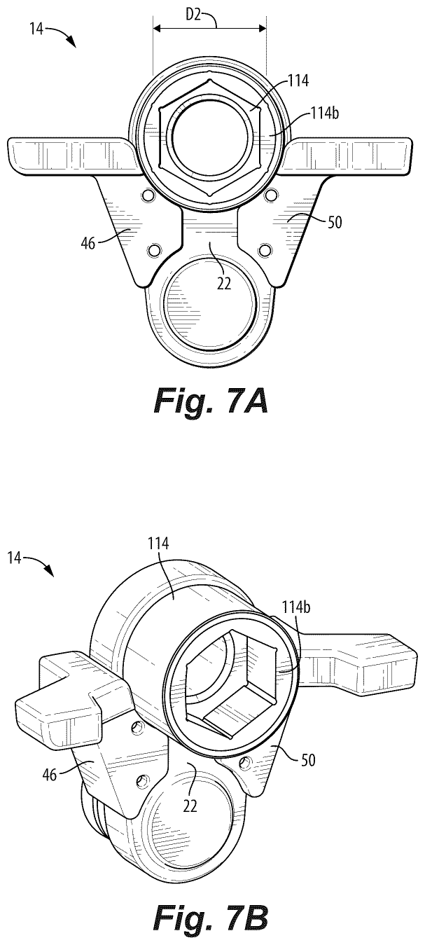

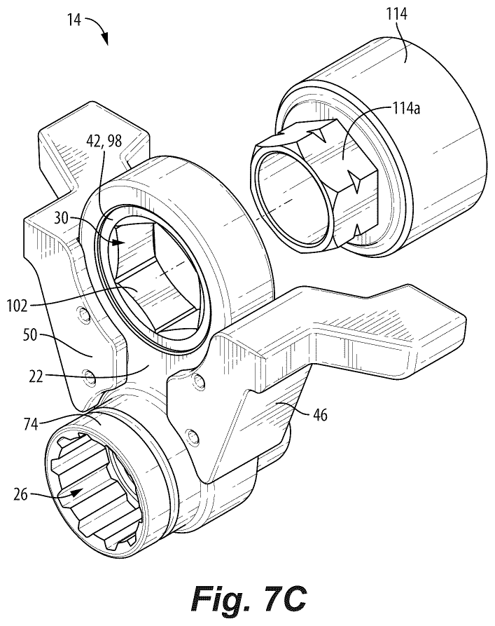

Two exemplary fastener engagement inserts 110, 114 are described and illustrated in this disclosure. However, it is understood that the offset drive accessory 14 may be compatible with any number of inserts, as will be described in more detail below. Specifically, FIGS. 2A, 5A, and 6 illustrate a first fastener engagement insert 110, and FIGS. 7A-7C illustrate a second fastener engagement insert 114. With reference to FIGS. 2A, 5A, and 6, the first fastener engagement insert 110 includes a first shank 110a and a first work end 110b. Referring to FIGS. 7A-7C, the second fastener engagement insert 114 includes a second shank 114a and a second work end 114b. With reference to FIGS. 6 and 7C, the first shank 110a and the second shank 114a are identical. As such, the first shank 110a and the second shank 114a may be interchangeably received in the output receptacle 102 of the output gear 42, which may be desirable to engage fasteners of different sizes. That is, each insert 110, 114 may be configured to drive a fastener of a different size. In the illustrated embodiment, the first shank 110a and the second shank 114a are formed as hex shanks (i.e., hexagonally shaped shanks). In other embodiments, the first shank 110a and the second shank 114a may have a different shape that corresponds to a shape of the output receptacle 102 to couple the insert 110, 114 for co-rotation with the output gear 42.

With reference to FIGS. 2A, 5A, 7A, and 7B, the first work end 110b and the second work end 114b have different geometries (e.g., diameter, depth, shape, or the like). For example, in the illustrated embodiment, the first work end 110b has a first inner dimension D1, the second work end 114b has a second inner dimension D2, and the first inner dimension D1 and the second inner dimension D2 are different. In the illustrated embodiment, the first work end 110b and the second work end 114b have the same shape. In some embodiments, the first work end 110b and the second work end 114b may have different shapes. Although only two exemplary fastener engagement inserts 110, 114 are described in detail herein, it is understood that any number of fastener engagement inserts with work ends of varying sizes and a shank similar to the shanks 110a, 114a may be operably coupled to the output gear 42.

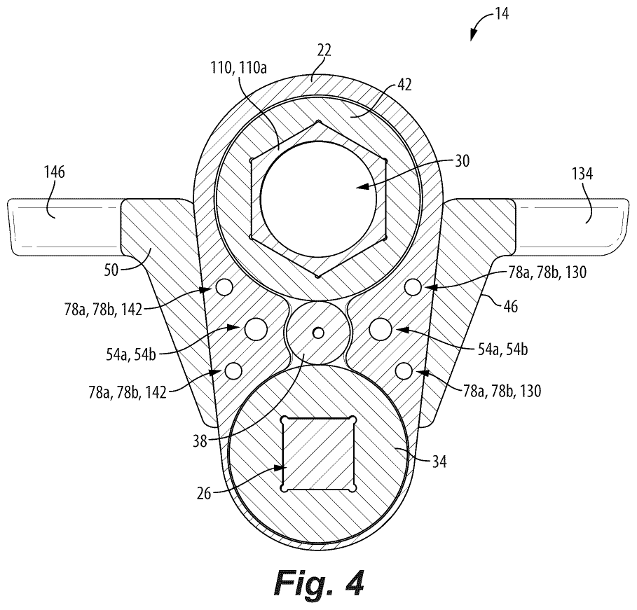

Referring to FIGS. 3 and 4, in the illustrated embodiment, the input gear 34 and the output gear 42 are substantially the same size as each other. As such, the input gear 34 and the output gear 42 have a gear ratio of 1:1 and are configured to rotate at the same rate of rotations per minute (“rpm”) and output the same amount of torque as each other. The idler gear 38 is provided between the input gear 34 and the output gear 42 to enable the input gear 34 and the output gear 42 to rotate in the same direction. However, the size of the idler gear 38 does not affect the amount of torque that will be outputted by the output gear 42 because the input gear 34 and the output gear 42 have the same size. In some embodiments, the output gear 42 may have a different size than the input gear 34 such that the input gear 34 and the output gear 42 are configured to output different torques. For example, the gear ratio may be between 3:1 and 1:3 in some embodiments. In further embodiments, the ratio may be between 5:1 and 1:5. However, with reference to FIGS. 2A and 7B, regardless of the size of the work end 110b, 114b for the fastener engagement insert 110, 114 that is coupled to the output gear 42, the amount of torque applied to a fastener will remain the same. That is, for any given gear ratio, the output torque that is applied to a fastener will remain constant. Therefore, the offset drive accessory 14 is configured to apply the same torque ratio from the power tool 10 to the fastener regardless of fastener size.

As illustrated in FIGS. 3 and 5B, the first reaction arm 46 is a forward direction reaction arm that is positioned in front of the input gear 34 and the output gear 42 along the forward rotational direction B1. As such, the first reaction arm 46 is configured to brace the tool 10 against a fixed structure (e.g., an adjacent fastener, a wall, a clamp, etc.) to bear the reaction torque when the power tool 10 drives the input gear 34 and the output gear 42 in the forward rotational direction B1. The second reaction arm 50 is a reverse direction reaction arm that is positioned in front of the input gear 34 and the output gear 42 along the rearward rotational direction B2. In other words, the second reaction arm 50 is positioned behind the input gear 34 and the output gear 42 along the forward rotational direction B1. As such, the second reaction arm 50 is configured to brace the tool 10 against a fixed structure (e.g., an adjacent fastener, a wall, a clamp, etc.) to bear the reaction torque when the power tool 10 drives the input gear 34 and the output gear 42 in the rearward rotational direction A2.

The first reaction arm 46 includes a pair of coupling flanges 126, a plurality of coupling receptacles 130 that are defined through both of the coupling flanges 126, and an arm portion 134 extending from the coupling flanges 126. The coupling flanges 126 and the coupling receptacles 130 facilitate removable coupling between the first reaction arm 46 and the housing 22. Specifically, the pair of coupling flanges 126 of the first reaction arm 46 may be slid onto an external side, or face, of the housing 22 such that the housing 22 is positioned between the coupling flanges 126 and the coupling receptacles 130 align with corresponding reaction arm fastener receptacles 70a,70b defined in the housing 22. The first reaction arm 46 may therefore be attached and removed from the housing 22 without decoupling the first housing portion 54a and the second housing portion 54b from each other. The arm portion 134 is configured to brace the tool 10 against a fixed structure (e.g., an adjacent fastener, a wall, a clamp, etc.) to bear reaction torque during a working operation.

The second reaction arm 50 includes a pair of coupling flanges 138, a plurality of coupling receptacles 142 that are defined through both of the coupling flanges 138, and an arm portion 146 extending from the coupling flanges 138. The coupling flanges 138 and the coupling receptacles 142 facilitate removable coupling between the second reaction arm 50 and the housing 22. Specifically, the pair of coupling flanges 138 of the second reaction arm 50 may be slid onto an external side, or face, of the housing 22 such that the housing 22 is positioned between the coupling flanges 138 and the coupling receptacles 142 align with corresponding reaction arm receptacles 70a, 70b defined in the housing 22. The second reaction arm 50 may therefore be attached and removed from the housing 22 without decoupling the first housing portion 54a and the second housing portion 54b from each other. The arm portion 146 is configured to brace the tool 10 against a fixed structure (e.g., an adjacent fastener, a wall, a clamp, etc.) to bear reaction torque during a working operation. When both of the reaction arms 46, 50 are coupled to the housing 22, the arm portions 134, 146 of each respective reaction arm 46, 50 extend, at least partially, in opposite directions from one another.

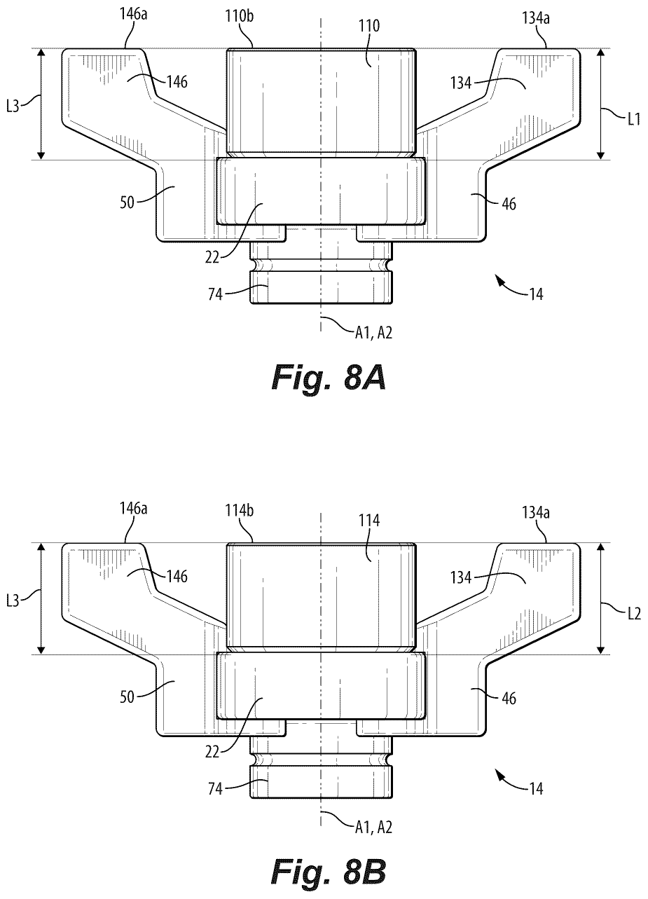

With reference to FIGS. 8A and 8B, the first work end 110b of first fastener engagement insert 110 is positioned a first distance L1, measured parallel to the axes A1, A2, from the housing 22, and the second work end 114b is positioned a second distance L2, measured parallel to the axes A1, A2, from the housing 22. In the illustrated embodiment, the first distance L1 and the second distance L2 are equal. In other embodiments, the distances L1, L2, may be different such that one of the distances L1, L2 is shorter than the other of the distances L1, L2. The arm portions 134, 146 of each reaction arm 46, 50 extend a third distance L3, measured parallel to the axes A1, A2, from the housing 22. That is, a distal end 134a, 146a of each arm portion 134, 146 is positioned a third distance L3, measured parallel to the axes A1, A2, from the housing 22. The third distance L3 may be less than or equal to a smaller one of the first distance L1 and the second distance L2 in order to avoid creating an interference with external structures during a working operation of the power tool 10 and the offset drive accessory 14. As such, the third distance L3 may be less than or equal to the distance between the housing 22 and the work end for any fastener engagement insert that is operably coupled to the offset device to perform a working operation.

The offset drive accessory 14 described and illustrated herein advantageously allows a user to easily configure the accessory 14 for workpieces (e.g., fasteners) of varying sizes. Specifically, the design of the offset drive accessory 14 enables a user to reconfigure the device without swapping out the output gear 42. Without replacing the output gear 42, the gear ratio between the input gear 34 and the output gear 42 does not change. Therefore, a user does not have to do the math to calculate a torque output each time the offset drive accessory 14 is reconfigured for use with fasteners of different sizes. Rather, the user can simply swap out one fastener engagement insert (e.g., the first fastener engagement insert 110) for another insert (e.g., the second fastener engagement insert 114).

Although the disclosure has been described in detail with reference to certain example embodiments, variations and modifications exist within the scope and spirit of one or more independent aspects of the disclosure as described.

Various features of the disclosure are set forth in the following claims.

1. An offset drive accessory for a power tool, comprising:
a housing;
an input gear supported within the housing, the input gear configured to rotate about a first axis;
an output gear supported within the housing, the output gear configured to rotate about a second axis offset from the first axis, wherein the output gear is couplable to a removable insert that is engageable with a fastener to transmit torque from the output gear to the fastener;
an idler gear supported within the housing, the idler gear meshed with the input gear and the output gear such that the idler gear is configured to transmit torque from the input gear to the output gear; and
a reaction arm removably coupled to the housing.

2. The offset drive accessory of claim 1, wherein the insert is one of a plurality of interchangeable inserts, each interchangeably couplable to the output gear.

3. The offset drive accessory of claim 1, wherein the output gear includes a receptacle, and wherein the insert includes a shank insertable into the receptacle to couple the insert for co-rotation with the output gear.

4. The offset drive accessory of claim 1, wherein the housing includes a first housing portion having a first coupling edge and a second housing portion having a second coupling edge, wherein the first coupling edge and the second coupling edge are in contact with each other at a plane.

5. The offset drive accessory of claim 4, wherein the first axis and the second axis extend through the plane.

6. The offset drive accessory of claim 4, wherein the plane is perpendicular to both the first axis and the second axis.

7. The offset drive accessory of claim 4, wherein the reaction arm is removably coupled to the housing on an external side of the housing such that the reaction arm is removable from the housing without decoupling the first housing portion and the second housing portion.

8. The offset drive accessory of claim 1, wherein the reaction arm is a first reaction arm, wherein the first reaction arm is removably coupled to the housing at a first position on an exterior of the housing, wherein the offset drive accessory further comprises a second reaction arm removably coupled to the housing at a second position on the exterior of the housing.

9. An offset drive accessory for a power tool, comprising:
a housing,
an input gear supported by the housing and configured to be rotatably driven about a first axis by an output drive of the power tool;
an output gear supported by the housing and rotatable about a second axis parallel to the first axis in response to rotation of the input gear, wherein the output gear includes an output receptacle;
a first insert including a first shank shaped to be received in the output receptacle and a first work end having a first geometry; and
a second insert including a second shank shaped to be received in the output receptacle and a second work end having a second geometry different than the first geometry,
wherein the first insert and the second insert are interchangeably couplable with the output gear.

10. The offset drive accessory of claim 9, wherein the first work end is configured to receive a fastener of a first size, and wherein the second work end is configured to receive a fastener of a second size different than the first size.

11. The offset drive accessory of claim 9, wherein the output receptacle is hexagonally shaped, and wherein the first shank and the second shank are hexagonally shaped.

12. The offset drive accessory of claim 9, further comprising a reaction arm removably coupled to the housing.

13. The offset drive accessory of claim 12, wherein the first working end extends a first distance from the housing along the second axis when the first insert is coupled to the output gear, wherein the second working extends a second distance from the housing along the second axis when the second insert is coupled to the output gear, wherein the reaction arm extends a third distance from the housing in a direction parallel to the second axis when the reaction arm is coupled to the housing, and wherein the third distance is less than or equal to the first distance and the second distance.

14. The offset drive accessory of claim 9, further comprising an idler gear.

15. An offset drive accessory for a power tool, comprising:
a housing,
an input gear supported by the housing and configured to be rotatably driven about a first axis by an output drive of the power tool; and
an output gear supported by the housing and rotatable about a second axis parallel to the first axis in response to rotation of the input gear, wherein the output gear includes an output receptacle,
wherein the offset drive accessory includes a first configuration in which the offset drive accessory is configured to drive a fastener of a first size,
wherein the offset drive accessory includes a second configuration in which the offset drive accessory is configured to drive a fastener of a second size different than the first size, and
wherein a gear ratio between the input gear and the output gear remains constant in the first configuration and the second configuration.

16. The offset drive accessory of claim 15, wherein the gear ratio is between 3:1 and 1:3.

17. The offset drive accessory of claim 16, wherein the gear ratio is 1:1.

18. The offset drive accessory of claim 15, further comprising a first insert coupled to the output gear when the offset drive accessory is in the first configuration and a second insert coupled to the output gear when the offset drive accessory is in the second configuration.

19. The offset drive accessory of claim 15, further comprising an idler gear meshed with the input gear and the output gear such that the idler gear is configured to transmit torque from the input gear to the output gear.

20. The offset drive accessory of claim 15, further comprising a reaction arm removably coupled to the housing.
